(19) United States
(12) Patent Application Publication
(10) Pub. No.: US 2010/0020984 A1
(43) Pub. Date: Jan. 28, 2010

(54) SIGNAL PROCESSING SYSTEM AND METHOD

(75) Inventors: Cornelis Pieter Janse, Eindhoven (NL); Rene Martinus Maria Derkx, Eindhoven (NL); Marie-Bernadette Gennotte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/513,529

(22) PCT Filed: Nov. 8, 2007
(86) PCT No.: PCT/IB2007/054541

§ 371 Date: May 5, 2009

(30) Foreign Application Priority Data
Nov. 10, 2006 (EP) 06123834.1

(51) Int. Cl. H04B 15/00

(52) U.S. Cl. 381/93; 381/119

(57) ABSTRACT

A signal processing system comprises a microphone (20), a subtractor (22) arranged to receive an output of the microphone (20), an amplifier G arranged to receive an output of the subtractor (22), a rear loudspeaker (24) arranged to receive an output of the amplifier G, a front loudspeaker (26) arranged to receive an output of the amplifier G, and one or more summers (28) interposed between the amplifier G and a loudspeaker (24, 26), the or each summer (28) arranged to add an audio signal m[k] to the signal s[k] received from the amplifier G. The system also includes a mixing matrix D arranged to receive the respective inputs R, F of the rear and front loudspeakers (24, 26) and arranged to output a summation signal R+F and a difference signal R−F, and an adaptive filter SAF; MCAF arranged to receive the outputs R+F, R−F of the mixing matrix D, the subtractor (22) arranged to receive an output of the adaptive filter SAF; MCAF and an output of the subtractor (22) arranged to control the adaptive filter SAF; MCAF.

This invention relates to a signal processing system and to a method of operating the signal processing system. The signal processing system is particularly suitable for use in a speech reinforcement system, for example in a vehicle.

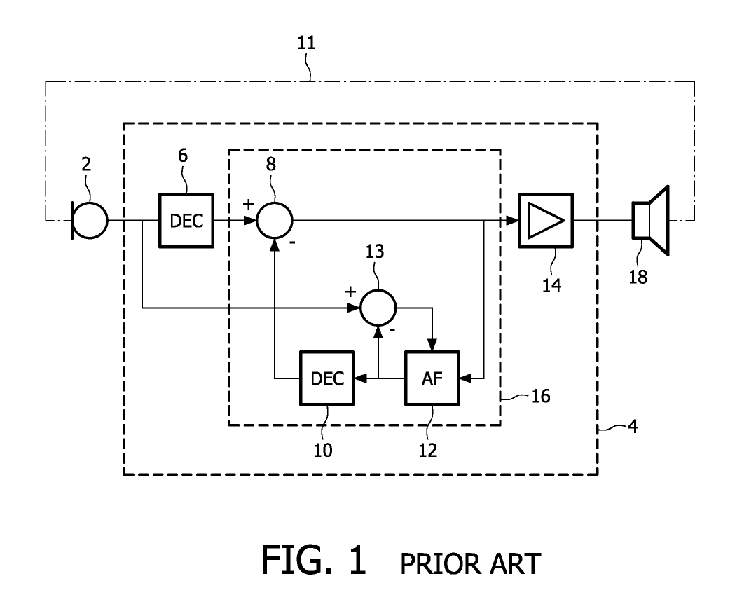

Reinforcement of the speech of passengers via a car-loudspeaker system improves the intelligibility of this speech for other passengers in a car. In FIG. 1, a prior art speech reinforcement system is shown that is known from the U.S. Pat. No. 5,748,751. In the signal amplifier system shown in FIG. 1, an output of a microphone 2 is connected to an input of the signal processing system 4.

The input of the signal processing system is connected to an input of decorrelator 6 and to a first input of a subtracter circuit 13. The output of the decorrelator 6 is connected to an input of the echo canceller 16. Inside the echo canceller 16, this input is connected to a first input of a subtracter circuit 8. The output of the subtracter circuit 8 is connected to the output of the echo canceller 16 and to a signal input of an adaptive filter 12. An output of the adaptive filter 12 is connected to an input of a further decorrelator 10 and to a second input of the subtracter circuit 13. The output of the subtracter circuit 13 is connected to a residual signal input of the adaptive filter 12. The output of the further decorrelation means 10 is connected to a second input of the subtracter circuit 8.

The output of the echo canceller is connected to an input of a power amplifier 14 whose output is connected to an input of a loudspeaker 18. The (undesired) feedback path 11 is denoted in a dash-and-dot line. In the signal amplifier system shown in FIG. 1, the signal generated by the microphone is decorrelated by decorrelator 6, so that the cross-correlation function of the input signal and the output signal of the decorrelator 6 is reduced. The decorrelator 6 is generally a time-variant system, which, in addition, may be non-linear.

With a standard speech-reinforcement system the microphone picks up the speech of the speaking person. A processed version of this speech is reproduced by loudspeakers, which are located close to the listening person(s). To perceive this speech in noisy environments (such as a car), a reinforcement gain (from the amplifier 14) is required prior to the reproduction of the speech via the loudspeakers. However, for large reinforcement gains, the open-loop gain of the complete electro-acoustic loop will be larger than one, for certain frequencies, which will result in the audio artefact of “howling”.

In order to prevent the howling effect in the case of large reinforcement gains, an acoustic feedback suppressor system is required. This feedback suppressor system comprises an adaptive filter (AF) that estimates the feedback and subtracts it (at the point of the subtracter 8 in FIG. 1). The adaptive filter will only work properly when the speech coming from the loudspeakers is decorrelated from the speech coming from the speaking person. For this decorrelation, a frequency-shifter is used. The adaptive-filter and frequency-shifter combination is called a feedback canceller. With the feedback canceller, the acoustic path between the loudspeaker(s) and the microphone is estimated.

In FIG. 1, speech-reinforcement is only applied for the uni-directional front to rear communication situation. It is recognized that the rear to front speech-reinforcement is less beneficial, as the speech of the rear-passengers has a directivity pattern towards the ears of the front-passengers. Nevertheless, for large-size cars (e.g. vans), an extension to bi-directional communication can be beneficial. Such a bi-directional system is shown for example in U.S. Pat. No. 6,674,865.

In a vehicle it will often be the case that besides the speech-reinforcement (played by the rear loudspeaker), an audio signal is reproduced (played by both the rear and the front loudspeaker). Before amplifying the front microphone signal with the speech communication system via the rear loudspeaker, it is required to cancel the audio signal in this microphone. This is shown in the prior art of U.S. Pat. No. 6,674,865. However, the prior art of U.S. Pat. No. 6,674,865 fails when the audio signal played by the front loudspeaker is equal to or correlated with the signal played by the rear loudspeaker. The reason for this problem is caused by the fact that the audio is played on both loudspeakers while the speech for the speech communication in played on only a single loudspeaker. This will result in a non-unique path identification.

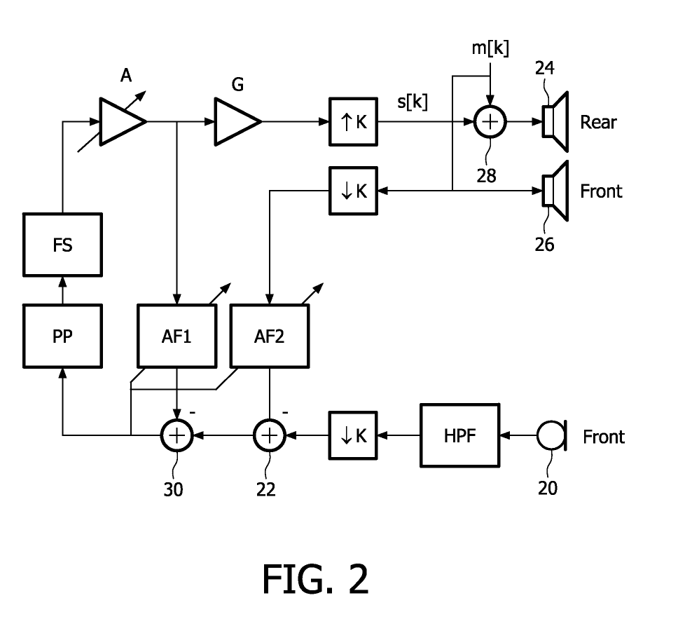

A trivial and straightforward solution to this problem is to introduce a separate adaptive filter for the audio signal cancellation, having the audio signal as a reference input. This is shown in FIG. 2 for the uni-directional front-to-rear communication situation. The main disadvantage of the system in FIG. 2 is that the audio signal cannot improve the adaptation of the feedback canceller.

It is therefore an object of the invention to improve the adaptation and the tracking-speed of the feedback canceller by exploiting the audio signal.

According to a first aspect of the present invention, there is provided a signal processing system comprising a microphone, a subtractor arranged to receive an output of the microphone, an amplifier arranged to receive an output of the subtractor, a rear loudspeaker arranged to receive an output of the amplifier, a front loudspeaker arranged to receive an output of the amplifier, one or more summers interposed between the amplifier and a loudspeaker, the or each summer arranged to add an audio signal to the signal received from the amplifier, a mixing matrix arranged to receive the respective inputs of the rear and front loudspeakers and arranged to output a summation signal and a difference signal, and an adaptive filter arranged to receive the outputs of the mixing matrix, the subtractor arranged to receive an output of the adaptive filter and an output of the subtractor arranged to control the adaptive filter.

According to a second aspect of the present invention, there is provided a method of operating a signal processing system comprising; receiving, at a microphone, a signal, receiving, at a subtractor, an output of the microphone, amplifying, at an amplifier, an output of the subtractor, outputting, at a rear loudspeaker, an output of the amplifier, receiving, at a front loudspeaker, an output of the amplifier, adding an audio signal, at a summer interposed between the amplifier and a loudspeaker, to the signal received from the amplifier, receiving, at a mixing matrix, the respective inputs of the rear and front loudspeakers and outputting, from the mixing matrix, a summation signal and a difference signal, filtering, at an adaptive filter, the outputs of the mixing matrix, receiving, at the subtractor, an output of the adaptive filter, and controlling, with an output of the subtractor, the adaptive filter.

The system provides reinforcement of the speech of passengers via a car-loudspeaker system thereby improving the intelligibility of this speech perceived by other passengers in a car. The speech-reinforcement system performs a feedback cancellation in order to alleviate the well-known howling phenomenon. To estimate the feedback that needs to be cancelled, an acoustic path identification is made. In this system, the presence of audio-signals (for example, stereo-music) is exploited to improve the identification of the acoustic path required for the feedback cancellation.

Preferably, the system further comprises a post processor interposed between the subtractor and the amplifier, the post processor arranged to apply noise reduction to the signal received from the subtractor. The system can use a (spectral) post processor (PP). The most important task of this post processor is to suppress the (additive) noise components that are present in a car. If this noise is not cancelled sufficiently, the noise would be reinforced via the system and would lead to an increase of the total noise level in the car.

Another task of the post processor is to suppress feedback components that are not sufficiently cancelled by the adaptive filter. Especially during movements in the car, the adaptive filter cannot track the Wiener solution quickly enough and the post processor acts as a backup. Yet another task of the post processor is to apply a dereverberation of the signal picked up by the microphone. When the gain G (from the amplifier) is put to a high value that is much higher than the original howling-bound, the reinforced speech sounds reverberated. In order to make the speech more natural, a dereverberator is applied.

Advantageously, the system further comprises a frequency shifter interposed between the subtractor and the amplifier, the frequency shifter arranged to apply a frequency shift to the signal received from the subtractor. The frequency-shifter shifts the entire signal by 5 Hz. By means of this frequency-shifter alone, howling at a single frequency is avoided in the situation where the gain-factor G (applied by the amplifier) is increased to a level greater than would be allowed when no signal processing is carried out. With a frequency-shifter, the gain G can be increased beyond the original howling-bound. The reason for the increased howling bound is that, because of the frequency-shift, every round-trip the averaged open loop gain (over frequency) must be below one, instead of the open loop gain at each frequency.

Another advantage of using the frequency-shifter is that the desired speech signal is decorrelated from the loudspeaker signal. As a result from this frequency shift, the adaptive filter can converge to a solution that is equal to the acoustic path between the rear loudspeaker and the front microphone. Assuming that the adaptive filter coefficients w[k] start from the all-zero vector, and that there are no changes in the acoustic path, the adaptive filter coefficients converge to the Wiener solution:

$${lim}_{k -> ∞} \underline{w} [ k ] = G \cdot {\underline{h}}_{RF} , \qquad ( 1 )$$

-index and G*h_{rf} is the Wiener solution. This solution is basically a truncated (and scaled) version of the acoustic path from the rear loudspeaker to the front microphone. For the adaptive filter, one can use several adaptive filter types, like Normalized Least Mean Squares (NLMS), Frequency-Domain Adaptive Filter (FDAF) etc. With the filter w[k], the acoustic feedback can be compensated and the howling-bound is improved even more.

Ideally, the system further comprises a variable gain attenuator interposed between the subtractor and the amplifier, the variable gain attenuator arranged to attenuate the signal received from the subtractor. The variable attenuator is controlled by the background noise present (for example in a car, if the system is used in such a vehicle). The amount of attenuation is adjusted inverse proportionally with the amount of noise (or music) that is measured (or estimated) in the car. In case a lot of noise is present (i.e. driving on the highway), the speech-reinforcement system is highly required and the variable attenuation is set to A=1. In situations with less noise, the variable attenuator will be adjusted to a lower value.

Another purpose of the variable attenuator is to limit the amount of speech reinforcement in case the output signal of the loudspeaker gets close to saturation. In this way the system is kept linear and the adaptive filter is able to continue the adaptation in a correct way.

Preferably, the system further comprises a high pass filter interposed between the microphone and the subtractor, the high pass filter arranged to filter the signal received from the microphone. As generally for lower frequencies (50-200 Hz) the vehicle noise is much more dominant compared to the passenger speech, the microphone signal is high-pass filtered (HPF) to prevent the amplification of the vehicle noise.

Embodiments of the present invention will now be described, by way of example only, with reference to the accompanying drawings, in which:

FIG. 1 is a schematic diagram of a prior art signal processing system,

FIG. 2 is a schematic diagram of a first embodiment of a signal processing system explaining the object of the invention,

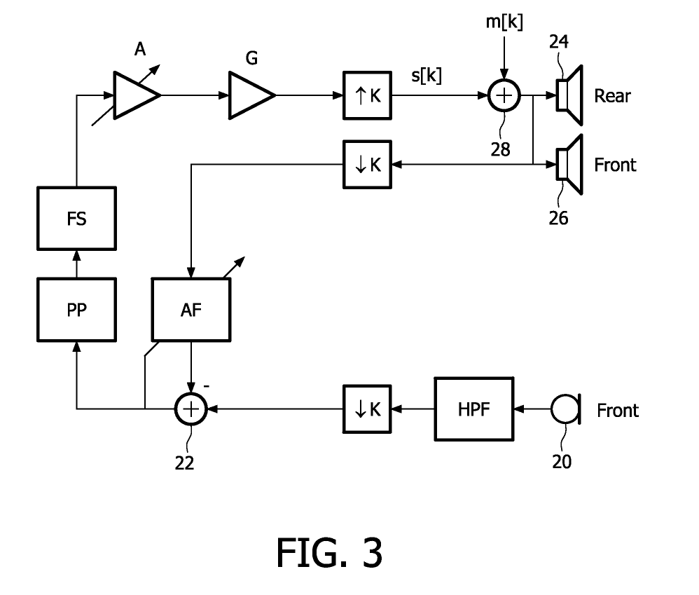

FIG. 3 is a schematic diagram of a second embodiment of a signal processing system explaining the object of the invention,

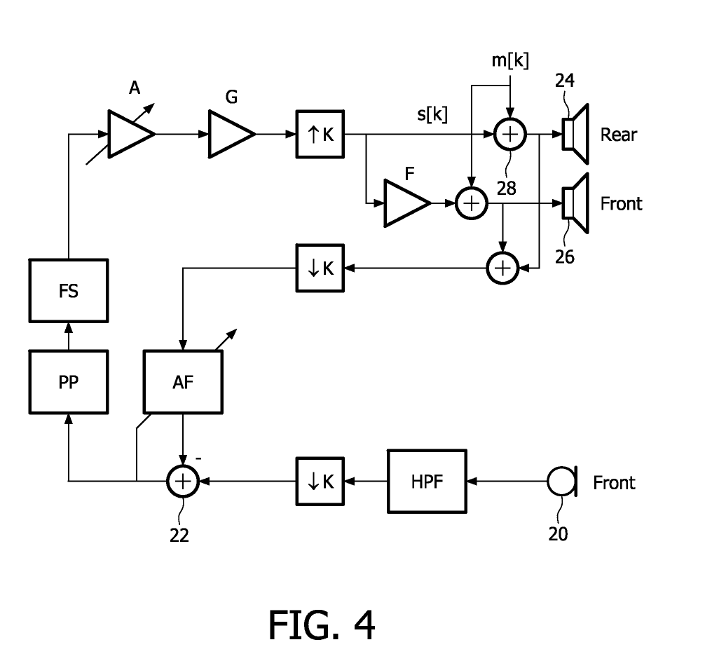

FIG. 4 is a schematic diagram of a third embodiment of a signal processing system explaining the object of the invention,

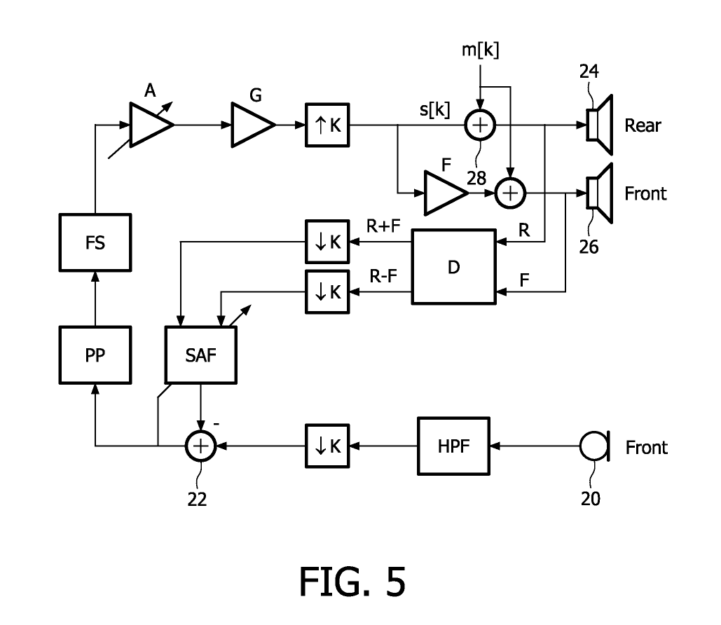

FIG. 5 is a schematic diagram of a fourth embodiment of a signal processing system according to the invention,

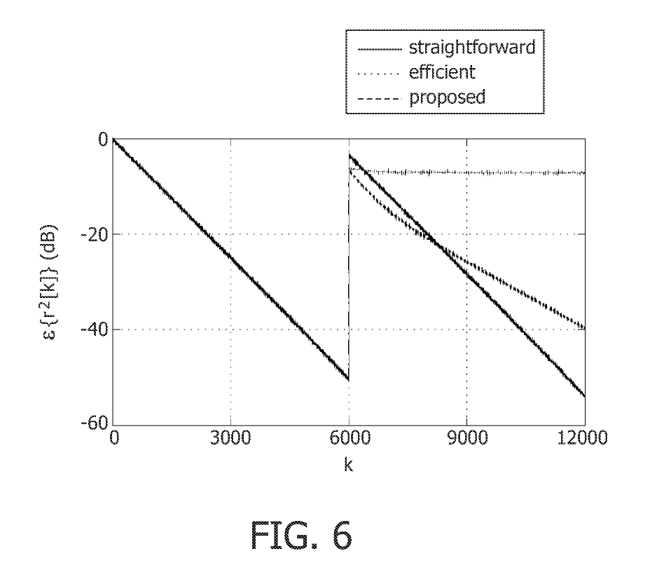

FIG. 6 is a diagram showing results of a simulation exercise,

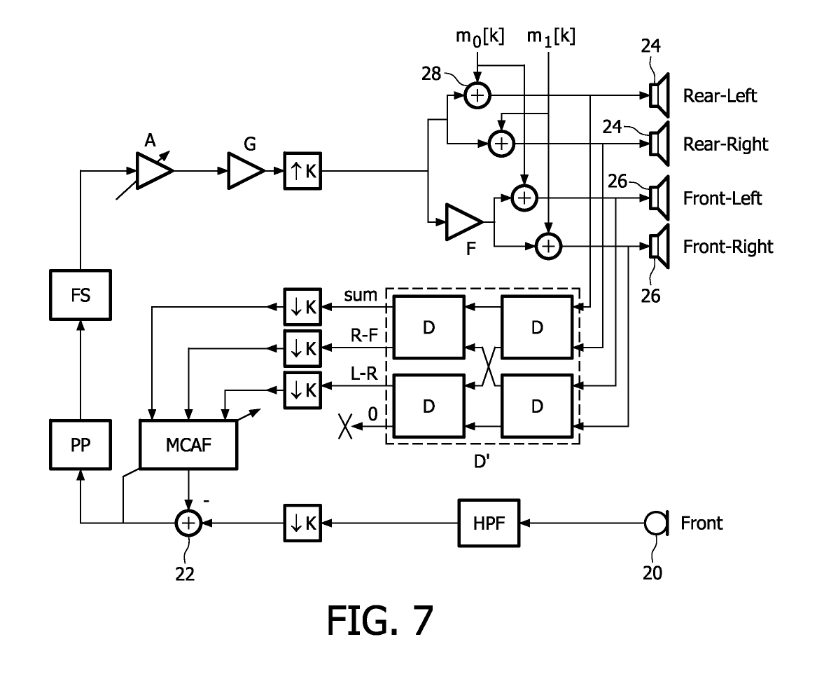

FIG. 7 is a schematic diagram of a fifth embodiment of a signal processing system according to the invention, and

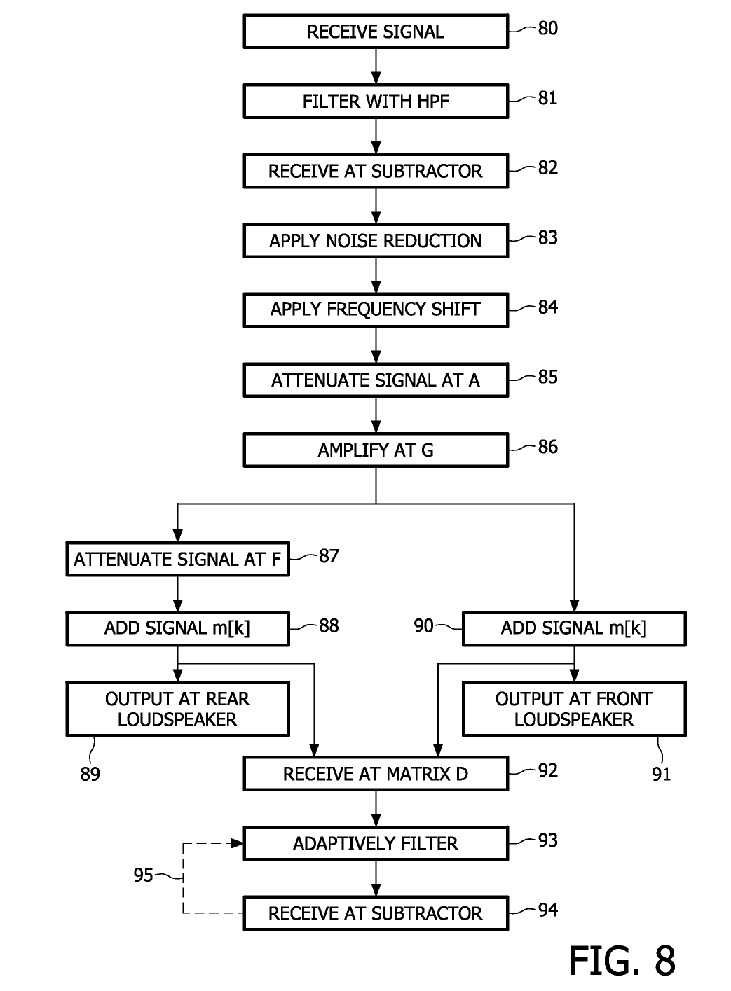

FIG. 8 is a flowchart of a method of operating a signal processing system.

FIG. 2 shows a first embodiment of an improved system for providing reinforcement of a passenger's speech in an environment such as a vehicle. In contrast to the prior art feedback-canceller application, such as that shown in FIG. 1, (where it can be argued that the audio should be muted during the communication), for the in-car communication it is likely that the audio is not switched off. This has to do with the fact that the communication between the passengers occurs at random moments and the communication is relatively short compared with the music connection time.

In systems such as that shown in FIG. 1, in the situation when other audio is present, the sound-reinforcement system will also reinforce this audio, which is undesired and should be cancelled by a separate adaptive-filter. FIG. 2 shows a first solution. In FIG. 2, the audio is represented by m[k] and is reproduced by both the front and the rear loudspeakers 24 and 26. For sake of simplicity, only a mono-channel audio signal m[k] will be considered. An extension to stereo or even multi-channel audio signals is possible. The speech that is being reinforced is represented by s[k]. A summer 28 is interposed between the amplifier G and the rear loudspeaker 24, the summer 28 being arranged to add the audio signal m[k] to the signal s[k] received from the amplifier G.

The signal processing system of FIG. 2 comprises a microphone 20, a subtractor 22 arranged to receive an output of the microphone 20, an amplifier G arranged to receive an output of the subtractor 22 (via the components PP, FS and the attenuator A), a rear loudspeaker 24 arranged to receive an output of the amplifier G together with the audio signal m[k], a front loudspeaker 26 arranged to receive the audio signal m[k], and an adaptive filter AF2 arranged to receive the audio signal m[k].

The subtractor 22 is also arranged to receive an output of the adaptive filter AF2 and an output of the subtractor 22 is arranged to control the adaptive filter AF2. A second subtractor 30 is interposed between the subtractor 22 and the amplifier G, and a second adaptive filter AF1 is arranged to receive the input of the amplifier G. The second subtractor 30 is arranged to receive an output of the second adaptive filter AF1 and an output of the second subtractor 30 is arranged to control the second adaptive filter AF1.

The system also comprises a post processor PP interposed between the subtractor 22 and the amplifier G, the post processor PP arranged to apply noise reduction to the signal received from the subtractor 22. A frequency shifter FS is also interposed between the subtractor 22 and the amplifier G, the frequency shifter FS arranged to apply a frequency shift to the signal received from the subtractor 22.

A variable gain attenuator A is interposed between the subtractor 22 and the amplifier G, the variable gain attenuator A arranged to attenuate the signal received from the subtractor 22. The system also comprises a high pass filter HPF interposed between the microphone 20 and the subtractor 22, the high pass filter HPF arranged to filter the signal received from the microphone 20.

Furthermore, up- and down-samplers are required because of the combined sound reinforcement and audio reproduction. Generally, the audio content has a sampling rate of 44.1 or 48 kHz, while speech signals can be processed at a lower sampling rate, like 8, 11.025 or 16 kHz. Therefore, up- and down-samplers are needed, shown by the components K, with a factor K equal to, for example, 2, 3, 4 or 6.

In the embodiment of FIG. 2, in addition to the regular adaptive filter AF1 that performs the cancellation of the speech feedback, the second adaptive filter AF2 is used, which attempts to cancel the audio present in the front microphone 26 prior to the speech reinforcement taking place. While the filter AF1 identifies the acoustic path from the rear loudspeaker 26 to the front microphone 20, as shown in equation (1) above, the filter AF2 identifies a solution that is equal to the sum of the (truncated) acoustic paths from the front and the rear loudspeakers 24 and 26 to the front microphone 20:

$${lim}_{k -> ∞} {\underline{w}}_{1} [ k ] = G \cdot {\underline{h}}_{RF} , \\ {lim}_{k -> ∞} {\underline{w}}_{2} [ k ] = {\underline{h}}_{RF} + {\underline{h}}_{FF} , \qquad ( 2 )$$

wᵢ[k] are the coefficients of the i'th adaptive filter, h_{RF} is the (truncated) acoustic path from the rear loudspeaker 24 to the front microphone 20 and h_{RF}+h_{FF} is the (truncated) acoustic path from both loudspeakers 24 and 26 to the front microphone 20. Although not included in equation (2), the Wiener solution also includes the characteristics of the high-pass filter (HPF) and the up- and down-samplers.

The main difference between the audio-cancellation and the speech feedback cancellation is that the audio canceller can operate mainly in so-called “single-talk” mode, while the feedback canceller always operates in so-called “double-talk” mode. Single-talk means that the microphone merely picks up the signal that needs to be cancelled, while in double-talk situations, also the desired speech signal is present. The reason that feedback cancellers are always operating in double-talk mode is that the feedback of the desired speech and the desired speech itself are always (except for attacks and releases of the speech) present at the same time.

Since in the single-talk mode, acoustic paths can be identified more quickly and more accurately compared to the double-talk mode, it is beneficial to combine the two adaptive filters in FIG. 2 into a single adaptive filter, such that the single adaptive filter converges mainly during single-talk. This can be obtained in three scenarios where in all scenarios it is desired to obtain one path for both the sound reinforced speech and the audio. These three options are to reproduce the audio m[k] only at the rear, to decorrelate the audio in the front from the audio in the rear, and to reproduce the speech s[k] both in the front and the rear.

In the first option, the audio is not reproduced in the front of the car, which is obviously undesirable. In the second option (similar to the embodiment in U.S. Pat. No. 6,674,865), it would be necessary to have different signals reproduced at the front and the rear, while generally the front and the rear loudspeaker signals will be equal. This solution is not a practical situation. The third option is shown in FIG. 3, where the speech s[k] is played through both loudspeakers 24 and 26.

The second embodiment, shown in FIG. 3, only requires a single adaptive filter AF that identifies the sum of the acoustic paths, as follows:

$${lim}_{k -> ∞} \underline{w} [ k ] = {\underline{h}}_{RF} + {\underline{h}}_{FF} , \qquad ( 3 )$$

The front loudspeaker 26 is now arranged to receive an output of the amplifier G. By applying the reinforced speech to the front loudspeaker 26, in addition to the rear loudspeaker 24 however, there is created an additional problem. As generally the coupling between the front loudspeaker 26 and the front microphone 20 is larger than coupling between the rear loudspeaker 24 and the front microphone 20, the howling-bound is decreased drastically. In practical experiments in some vehicles (such as an Audi-A4), the front loudspeakers are very close to the feet of the front passengers. With each small foot movement, the adaptive filter AF carrying out the feedback cancellation needs to converge to a new solution and the system approaches instability. Therefore, the solution as presented in FIG. 3 is not robust.

FIG. 4 shows a third embodiment of the speech reinforcement system, which has an attenuation factor F added for the reproduction of the speech on the front loudspeaker 26, which will lead to a different solution for the filter coefficients w[k] for F<1 in the situation when either speech or audio is present.

In the special case when F=0, the filter coefficients converge to a non-unique solution. When only speech s[k] is present, the solution is equal to h_{RF}. When only audio m[k] is present, the solution is equal to (h_{RF+}h_{FF})/2.

$$\underline{w} [ k ] = {\underline{h}}_{RF} \\ when \text{:} \\ s [ k ] \neq 0 , m [ k ] = 0 , \\ \underline{w} [ k ] = \frac{{\underline{h}}_{RF} + {\underline{h}}_{FF}}{2} \\ when \text{:} \\ s [ k ] = 0 , m [ k ] \neq 0. \qquad ( 4 )$$

When both s[k] and m[k] are present, neither of the two solutions presented above are obtained. The actual solution that is obtained depends on the signals s[k] and m[k] In general, no stable solution is obtained and the adaptive filter always has to adapt.

To let the audio (at least to some extent) help the speech feedback-cancellation, it is desirable to combine the loudspeaker signals and feed these combined signals to an adaptive filter in such a way that stable solutions are obtained, independent of the speech/music ratio and allowing different loudspeaker volume settings for the music and the sound reinforced speech. Taking, for example, the situation where (mono-) music is played back over all loudspeakers and the reinforced speech is only reproduced at the rear loudspeakers (scenario of FIG. 4 with F=0). In this case, to obtain the combined signals, it is necessary to add and subtract the two loudspeaker signals. These combined signals can be fed to a stereo adaptive filter. Such a filter is described in U.S. Pat. No. 7,058,185, for example. This embodiment is shown in FIG. 5, with F=0 and with a mixing-matrix D, defined as:

$$D = ( \begin{matrix}1 & 1 \\ 1 & - 1\end{matrix} ) , \qquad ( 5 )$$

to obtain the combined signals.

In case only a (mono-) music signals is present only the sum signals contains energy and the “sum”-path is estimated by:

$${lim}_{k -> ∞} {\underline{w}}_{2} [ k ] = \frac{{\underline{h}}_{RF} + {\underline{h}}_{FF}}{2} . \qquad ( 6 )$$

If w[k] has been converged and a reinforced sound signal s[k] comes in, then the difference signal will also contain energy and the “difference” path will converge to:

$${lim}_{k -> ∞} {\underline{w}}_{1} [ k ] = \frac{{\underline{h}}_{RF} - {\underline{h}}_{FF}}{2} . \qquad ( 7 )$$

If h_{RF} and h_{FF} are independent and have equal energy (a reasonable assumption in practice), then there is the following equality:

$${‖ \frac{{\underline{h}}_{RF} - {\underline{h}}_{FF}}{2} ‖}^{2} = \frac{1}{2} {‖ {\underline{h}}_{RF} ‖}^{2} . \qquad ( 8 )$$

It means that the error at startup of the “difference” path is 3 dB lower than the error in the embodiment of FIG. 2. This is true not only during startup, but also during operation, when the acoustic paths change, for example due to movement of persons. When the attenuation factor is such that F≠0, in the embodiment of FIG. 5, then the improvement is even greater. For F=0.5, for example, the error of the “difference” path at startup is 9 dB lower when compared with the situation in the embodiment of FIG. 2.

The signal processing system of FIG. 5 includes the microphone 20, the subtractor 22 arranged to receive an output of the microphone 20, and the amplifier G arranged to receive the output of the subtractor 22. The rear loudspeaker 24 is arranged to receive the output of the amplifier G, as is the front loudspeaker 26. Summers 28 are interposed between the amplifier G and the loudspeakers 24, 26, the summers 28 being arranged to add an audio signal m[k] to the signal s[k] received from the amplifier G. The FIG. 5 embodiment has an attenuator F interposed between the amplifier G and the front loudspeaker 26, the attenuator F applying an attenuation factor to the signal received from the amplifier G, and further comprises a mixing matrix D interposed between the amplifier G and the stereo adaptive filter SAF, the mixing matrix D arranged to receive the respective inputs R, F of the rear and front loudspeakers 24, 26 and arranged to output a summation signal R+F and a difference signal R−F.

To show that the system of FIG. 5 is an embodiment preferred over the system of FIG. 2 and FIG. 4, a comparative performance is measured in a simulation where F=0. It is noted however that with values of 0<F<1, it is possible to obtain a solution in between the relative performances of the systems of FIG. 3 and FIG. 5. For the simulations, s[k] and m[k] were uncorrelated Gaussian random noise processes, with:

Σ{s²[k]}=Σ{m²[k]}, (9)

where Σ{ } denotes the ensemble-average operator. The gain of the amplifier G is set to one. Furthermore, the following were used:

h_{FF}=(1,0), (10)

h_{RF}=(0,1) (11)

where (1,0), for example, is an impulse-response with two taps (1 and 0 respectively). The three scenarios used in the simulation are listed in the table below:

| Scenario | FIG. | # NLMS | lim_{k->∞}w₁[k] | lim_{k->∞}w₂[k] |
|---|---|---|---|---|
| Straightforward | 2 | 2 | (1, 0) | (1, 1) |
| Efficient | 4 | 1 | (?, ?) | — |
| Proposed | 5 | 2 | (∵1/2♭, −∵1/2♭) | (∵1/2♭, −∵1/2♭) |

For the “proposed” (the preferred embodiment according to FIG. 5) scenario, two NLMS adaptive filters were used instead of a single stereo adaptive filter. This has the disadvantage that the convergence achieved was somewhat slower. For the simulation results, 12000 independent simulations were averaged, in order to obtain an ensemble average. For the first 6000 samples of the simulation, only the signal m[k] was present, while in the last 6000 samples both s[k] and m[k] were present. This is to show how the audio m[k] can help in the feedback cancellation of s[k] at k=6000. The results of the simulation are shown in FIG. 6.

From FIG. 6, it can be seen that from 0≦k≦6000, the convergence to the Wiener solution is equal for all three embodiments (FIGS. 4 and 5). At k=6000, the “straightforward” scenario (FIG. 2) is inferior to the other two systems. With the “efficient” scenario (FIG. 4), it can be seen that no further (significant) reduction is obtained. This is caused by the fact that only one adaptive filter is used and the solution of this filter depends on the signal s[k] and m[k]. Just as for the “straightforward” scenario, the “proposed” scenario (FIG. 5) converges after k=6000. The convergence is somewhat slower due to the fact that two NLMS adaptive filters were used, while that system will perform better if a single stereo adaptive filter is used. The difference between the “straightforward” and the “proposed” solution at k=6000 is exactly 3 dB. FIG. 5 is the preferred embodiment of the signal processing system.

In practice, in most vehicle environments, the audio signal will be a stereo signal with left and right components. Following the same principle outlined above with respect to FIG. 5, it is possible to combine the signal components and feed these signals to a multi-channel adaptive filter (MCAF) in such a way that a stable solution is obtained, independent of the speech/music ratio and/or mono/stereo ratio. An example of a multi-channel adaptive filter is shown in US 2002/0176585. The solution is shown in the system of FIG. 7. The mixing matrix D′ is given by:

$${D}^{′} ( \begin{matrix}D & 0 \\ 0 & D\end{matrix} ) R ( \begin{matrix}D & 0 \\ 0 & D\end{matrix} ) , \qquad ( 12 )$$

with R the bit-reversal matrix:

$$R = ( \begin{matrix}1 & 0 & 0 & 0 \\ 0 & 0 & 1 & 0 \\ 0 & 1 & 0 & 0 \\ 0 & 0 & 0 & 1\end{matrix} ) . \qquad ( 13 )$$

With RL, RR, FL, FR indicating rear-left, right-right, front-left, and front-right signals respectively, this results in:

$${D}^{′} ( \begin{matrix}RL \\ RR \\ FL \\ FR\end{matrix} ) = ( \begin{matrix}RL + RR + FL + FR \\ RL + RR - FL - FR \\ RL - RR + FL - FR \\ RL - RR - FL + FR\end{matrix} ) . \qquad ( 14 )$$

The sum-signal (RL+RR+FL+FR) contains mono-music and speech. The rear minus front signal (RL+RR−FL−FR) only contains speech (as in the mono-example before) and the left minus right signal (RL−RR+FL−FR) only contains music. The fourth signal (RL−RR−FL+FR) does not contain any signal and thus can be left out. It should be noted that the combinations with the mixing-matrix can be performed in different ways. However there are only a few combinations possible that yield a result where the output equals 0. The converged solution will converge to:

$$\begin{matrix}{lim}_{k -> ∞} {\underline{w}}_{1} [ k ] = \frac{{\underline{h}}_{RLF} + {\underline{h}}_{RRF} + {\underline{h}}_{RLF} + {\underline{h}}_{FRF}}{4} , & ( 15 ) \\ {lim}_{k -> ∞} {\underline{w}}_{2} [ k ] = \frac{{\underline{h}}_{RLF} + {\underline{h}}_{RRF} - {\underline{h}}_{RLF} - {\underline{h}}_{FRF}}{4} , & ( 16 ) \\ {lim}_{k -> ∞} {\underline{w}}_{3} [ k ] = \frac{{\underline{h}}_{RLF} - {\underline{h}}_{RRF} + {\underline{h}}_{RLF} - {\underline{h}}_{FRF}}{4} , & ( 17 )\end{matrix}$$

where, for example, h_{RLF} is the (truncated) acoustic path from the rear-left loudspeaker to the front microphone.

The various embodiments of the signal processing system can be applied within car entertainment systems, where speech reinforcement is required simultaneously with regular audio and/or GSM reproduction. More generally, the system can be used in sound reinforcement systems where also other known sources are reproduced that use other loudspeaker volume settings than the ones that are used for sound reinforcement.

The method of operating the signal processing system is shown in FIG. 8, which relates to the preferred embodiment of FIG. 5. The steps of the operating method are firstly receiving (step 80), at the microphone 20, the signal. This signal is filtered (step 81), at the high pass filter HPF interposed between the microphone 20 and the subtractor 22. This filtered signal is then received (step 82), at the subtractor 22.

The next step 83 is the applying of noise reduction, at the post processor PP, to the signal received from the subtractor 22. There is then the step 84, which comprises applying a frequency shift, at a frequency shifter FS. Step 85 comprises attenuating, at a variable gain attenuator (A), the signal (of course the actual level of attenuation may be zero). The signal is then amplified, at the amplifier G, step 86.

The output of the amplifier G is sent to both loudspeakers 24 and 26. The signal that is to be output at the rear loudspeaker 24 has an attenuation factor applied, at the attenuator F, (step 87). The attenuated signal then has added (step 88) the audio signal m[k], at a summer 28 interposed between the amplifier G and the rear loudspeaker 24, to the signal s[k] received from the amplifier G. This signal is finally outputted (step 89), at the rear loudspeaker 24. Similarly the signal destined for the front loudspeaker 26 has the audio signal m[k] added (step 90) and this is then output at the loudspeaker (step 91).

These two signals that are outputted by the loudspeakers (R and F) are received at the mixing matrix D (step 92). The matrix D receives the respective inputs R, F of the rear and front loudspeakers 24, 26 and outputs, from the mixing matrix D, a summation signal R+F and a difference signal R−F. These two signals are received by the stereo adaptive filter SAF, where they are filtered, shown as step 93. The output of the adaptive filter SAF is then received, at the subtractor 22 (step 94). Control of the adaptive filter SAF, with an output of the subtractor 22 is performed. This is shown by the dotted line 95. The subtractor 22 is carrying out the feedback suppression.

1. A signal processing system comprising a microphone (20), a subtractor (22) arranged to receive an output of the microphone (20), an amplifier (G) arranged to receive an output of the subtractor (22), a rear loudspeaker (24) arranged to receive an output of the amplifier (G), a front loudspeaker (26) arranged to receive an output of the amplifier (G), one or more summers (28) interposed between the amplifier (G) and a loudspeaker (24, 26), the or each summer (28) arranged to add an audio signal (m[k]) to the signal (s[k]) received from the amplifier (G), a mixing matrix (D) arranged to receive the respective inputs (R, F) of the rear and front loudspeakers (24, 26) and arranged to output a summation signal (R+F) and a difference signal (R−F), and an adaptive filter (SAF; MCAF) arranged to receive the outputs (R+F, R−F) of the mixing matrix (D), the subtractor (22) arranged to receive an output of the adaptive filter (SAF; MCAF) and an output of the subtractor (22) arranged to control the adaptive filter (SAF; MCAF).

2. A signal processing system according to claim 1, further comprising a post processor (PP) interposed between the subtractor (22) and the amplifier (G), the post processor (PP) arranged to apply noise reduction to the signal received from the subtractor (22).

3. A signal processing system according to claim 1, further comprising a frequency shifter (FS) interposed between the subtractor (22) and the amplifier (G), the frequency shifter (FS) arranged to apply a frequency shift to the signal received from the subtractor (22).

4. A signal processing system according to claim 1, further comprising a variable gain attenuator (A) interposed between the subtractor (22) and the amplifier (G), the variable gain attenuator (A) arranged to attenuate the signal received from the subtractor (22).

5. A signal processing system according to claim 1, further comprising an attenuator (F) interposed between the amplifier (G) and the front loudspeaker (26), the attenuator (F) applying an attenuation factor to the signal received from the amplifier (G).

6. A method of operating a signal processing system comprising;
receiving, at a microphone (20), a signal,
receiving, at a subtractor (22), an output of the microphone (20),
amplifying, at an amplifier (G), an output of the subtractor (22),
outputting, at a rear loudspeaker (24), an output of the amplifier (G),
receiving, at a front loudspeaker (26), an output of the amplifier (G),
adding an audio signal (m[k]), at a summer (28) interposed between the amplifier (G) and a loudspeaker (24, 26), to the signal (s[k]) received from the amplifier (G),
receiving, at a mixing matrix (D), the respective inputs (R, F) of the rear and front loudspeakers (24, 26) and outputting, from the mixing matrix (D), a summation signal (R+F) and a difference signal (R−F),
filtering, at an adaptive filter (SAF; MCAF), the outputs (R+F, R−F) of the mixing matrix (D),
receiving, at the subtractor (22), an output of the adaptive filter (SAF; MCAF), and
controlling, with an output of the subtractor (22), the adaptive filter (SAF; MCAF).

7. A method according to claim 6, further comprising applying noise reduction, at a post processor (PP) interposed between the subtractor (22) and the amplifier (G), to the signal received from the subtractor (22).

8. A method according to claim 6, further comprising applying a frequency shift, at a frequency shifter (FS) interposed between the subtractor (22) and the amplifier (G), to the signal received from the subtractor (22).

9. A method according to claim 6, further comprising attenuating, at a variable gain attenuator (A) interposed between the subtractor (22) and the amplifier (G), the signal received from the subtractor (22).

10. A method according to claim 6, further comprising applying an attenuation factor, at an attenuator (F) interposed between the amplifier (G) and the front loudspeaker (26), the signal received from the amplifier (G).
